(19) United States
(12) Patent Application Publication
(10) Pub. No.: US 2002/0169668 A1
(43) Pub. Date: Nov. 14, 2002

(54) Method, article of manufacture, and processing device for providing promotions over a network using an alphanumeric sequence from a product

(76) Inventors: Edward L. Bank, San Mateo, CA (US); Michael J. Comb, Dublin, CA (US); Juan Carlos Velten Funcia, San Francisco, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/071,562

(22) Filed: Feb. 8, 2002

Related U.S. Application Data
(60) Provisional application No. 60/267,585, filed on Feb. 9, 2001.

(51) Int. Cl. G06F 17/60

(52) U.S. Cl. 705/14

(57) ABSTRACT

According to an embodiment of the present invention, a method, article of manufacture including a computer readable medium, and a system including a processing device provides promotions over the Internet. In an embodiment of the present invention, a first entity (which in one example is an offline brand) distributes a product with an alphanumeric sequence. In an embodiment of the present invention, the alphanumeric sequence is hidden from view until the product is purchased. For example, the alphanumeric sequence is positioned on the inside of packaging. When a user purchases the product, the user can view the alphanumeric sequence. Printed with the alphanumeric sequence is an address on the Internet in an embodiment of the present invention. The user can enter the address into a browser and access the addressed page, which in one embodiment is part of the first entity's web page. The user selects a link indicating a desire to redeem a prize using the alphanumeric sequence. The user is directed to a web page that provides a means to enter the alphanumeric sequence, personal information and answers to survey questions. After the alphanumeric sequence is validated, the user is provided with a value. In one embodiment, the value includes a coupon for shopping at an online store. In an embodiment of the present invention, the values are not accumulated or combined.

### CLAIM OF PRIORITY

The present Application claims priority to U.S. Provisional Application Serial No. 60/267,585, entitled PROMOTION SERVICE PROVIDER, filed on Feb. 9, 2001.

### FIELD OF THE INVENTION

The present invention is directed toward providing promotions using a network, such as the Internet or a cellular network.

### BACKGROUND OF THE INVENTION

Advertisers, retailers and manufacturers provide consumers with incentives (e.g., “money saving” coupons, loyalty programs, discount offers, interactive activities and games) to encourage consumers to purchase products. For example, a company can provide, by way of mass mailings or through printed media, coupons or discount sales offers to provide the recipients with a strong incentive to purchase the company's products. Some advertisers mail direct payments to consumers (e.g., dollar bills, checks, or rebates). The consumer can use these direct payments to help pay for purchasing the advertiser's goods, or to purchase other related or unrelated goods or services. The primary drawback for the advertiser is lack of efficiency and customer interaction. The advertisements are delivered to many consumers who may have no interest in purchasing the products being advertised.

The Internet is a medium that reaches millions of people all over the world, and includes technology that is capable of targeting information directly to the individual consumer. This creates the potential to transform the interaction between consumer and advertiser and make the advertising process considerably more efficient.

Existing Internet-associated promotional systems deliver their promotional material over the Internet, often to consumers targeted by their demographic profile or patterns on web usage. However, these rely on the consumer to reach the online outlet of promotions or merchants on their own.

### SUMMARY

According to an embodiment of the present invention, a method, article of manufacture, including a computer readable medium, and a system, including a processing device, provides promotions over the Internet. In an embodiment of the present invention, a first entity (which in one example is an offline brand) distributes a product with an alphanumeric sequence. In an embodiment of the present invention, the alphanumeric sequence is hidden from view until the product is purchased. For example, the alphanumeric sequence is positioned on the inside of packaging. When a consumer purchases the product, the consumer can view the alphanumeric sequence. Printed with the alphanumeric sequence is an address on the Internet in an embodiment of the present invention. The user can enter the address into a browser and access the addressed page, which in an embodiment of the present invention is part of the first entity's web page. The consumer selects a link indicating a desire to redeem a known or unknown value, such as an electronic coupon, using the alphanumeric sequence. The consumer is directed to a web page that provides a means to enter the alphanumeric sequence, personal information and answers to survey questions. After the alphanumeric sequence is validated, the consumer is provided with a value and possibly other prizes. In an embodiment of the present invention, the value includes an electronic coupon for shopping at an online store. An electronic coupon is passed onto the online store in order for the consumer to receive a discount. In an embodiment of the present invention, the values are not accumulated or combined.

In an embodiment of the present invention, a method for providing a promotion comprises the steps of obtaining a product having an alphanumeric sequence and entering the alphanumeric sequence supplied with the product into a web site. The alphanumeric sequence is validated and an electronic coupon associated with the alphanumeric sequence is awarded. An item is chosen and purchased. The item is discounted based on the electronic coupon.

In an embodiment of the present invention, the validating step includes decoding the alphanumeric code to determine an associated electronic coupon.

In still another embodiment of the present invention, the method further comprises the step of collecting information from a buyer of the item.

In an embodiment of the present invention, the information is used for marketing purposes.

In an embodiment of the present invention, the choosing step includes accessing an online retailer web site or an electronic warehouse.

In an embodiment of the present invention, a method for providing a promotion comprises the step of applying an alphanumeric sequence to a product by a first retailer and selling the product by the first retailer to a user. A web site on a first retailer processing device is accessed by a user processing device. The user enters the alphanumeric sequence supplied with the product into a web page of the web site. The alphanumeric sequence is validated and an electronic coupon is awarded. A web site on a second retailer processing device is accessed by the user processing device. The user chooses and purchases an item. The item is discounted based on the electronic coupon.

According to an embodiment of the present invention, the electronic coupon can be increased responsive to the product being purchased during a predetermined period of time.

According to an embodiment of the present invention, the electronic coupon can be increased responsive to the product being purchased in a predetermined geographic area.

According to an embodiment of the present invention, the electronic coupon can be increased responsive to the user answering a question.

According to an embodiment of the present invention, the electronic coupon can be increased responsive to a predetermined date.

According to an embodiment of the present invention, the awarding the coupon step includes awarding a prize.

According to an embodiment of the present invention, the awarding the coupon step includes providing the second retailer that will redeem the coupon.

According to an embodiment of the present invention, the awarding the coupon step includes providing a user with an opportunity to enter a sweepstake contest.

According to an embodiment of the present invention, the awarding the coupon step includes providing the user with a visual game piece associated with the alphanumeric sequence. The user wins a prize in response to obtaining a plurality of predetermined visual game pieces.

According to an embodiment of the present invention, an article of manufacture includes a computer readable medium comprising a first software component for providing a value responsive to receiving an alphanumeric sequence from a first product. A second software component directs a user to a web site for purchasing a second product. A third software component allows for purchasing the second product using the value.

According to another embodiment of the present invention, the computer readable medium is positioned in a processing device coupled to the Internet and a client processing device access the processing device.

Other aspects and advantages of the present invention can be seen upon review of the figures, the detailed description, and the claims that follow.

### BRIEF DESCRIPTION OF THE FIGURES

FIG. 1 is a block diagram of a system according to embodiment of the present invention.

FIG. 2 is a block diagram of a processing device according to an embodiment of the present invention.

FIG. 3 is a flow chart describing a method according to an embodiment of the present invention.

FIG. 4 is a block diagram of software components according to an embodiment of the present invention.

### DETAILED DESCRIPTION

I. Overview

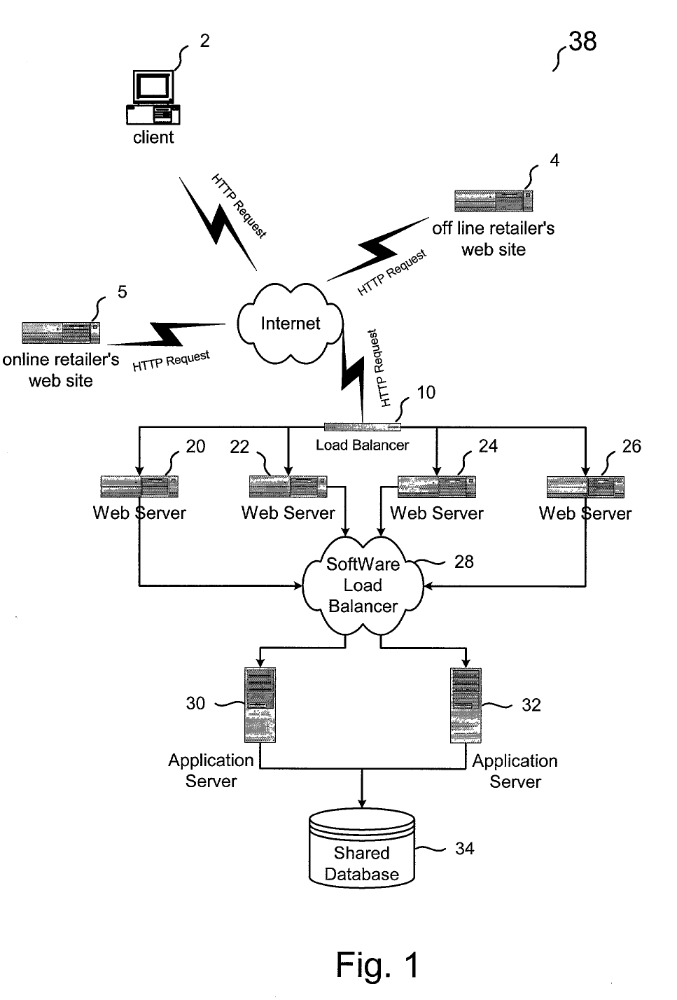

A Promotion Service Provider (“PSP”) system 38, as illustrated in FIG. 1, empowers an entity, such as a manufacture, distributor, retailer and/or advertiser, with a plug-and-play, Internet-based promotions infrastructure that allows them to offer real value, such as coupons, money and prizes, to their consumers in an embodiment of the present invention. System 38 allows manufactures, distributors, retailers and/or advertisers to launch a variety of promotion programs (offline-to-online cross-promotions, loyalty, sweepstakes, instant win, collect-and-get and games) to achieve specific marketing goals. Back-end technology maintains all the data gathering, storing and accountability for all programs. As a result, a promotion can be developed in a matter of weeks instead of months.

Manufactures, distributors, retailers and/or advertisers are also able access to powerful consumer relationship management features, such as targeted email marketing and ad serving, reporting and data analysis tools, and the ability to further develop consumer relationships and gain valuable insights. The end result is a fully branded Internet front-end that is flexible enough to achieve a brand's specific marketing and promotional goals, whether they be trial, repeat purchase or longer-term loyalty.

Manufactures, distributors, retailers and/or advertisers have several choices regarding the implementation of a PSP system 38. An entity can choose to integrate their web site with a PSP system 38 back-end technology, ensuring a seamless promotional program that maintains the navigation and functionality of the entity's own web site. This guarantees a fully branded consumer experience. Alternatively, for entities that do not have an Internet presence or web site, or choose not to launch promotions from their home page, a promotion provider can develop a unique gateway for the program through a promotion provider's web site (i.e. www.softcoin.com/brand).

A PSP system 38 serves as the launching pad and powers the promotion program's functionality. Entities can turn on and off any of these promotion features, depending on the type of programs desired during a specific period of time. Key features of system 38 include system security and consumer privacy, “Powered By” functionality, front-end branding, alphanumeric sequence generating and decoding algorithms, easy integration with an entities own site and online retail sites, and in-house customer support including live chat customer service features.

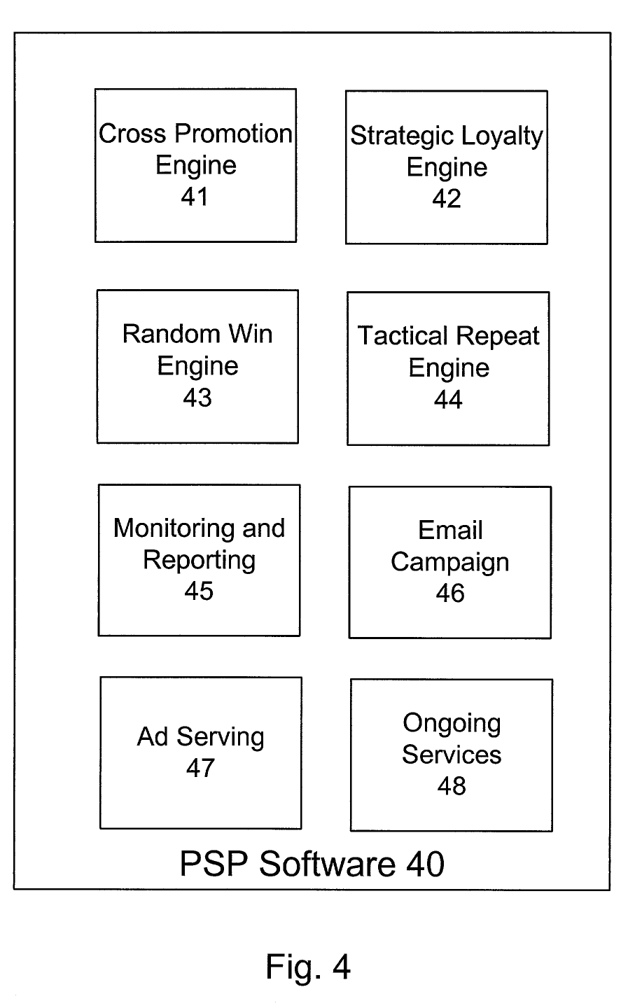

System 38 functions are performed partially or completely by PSP software 40 illustrated in FIG. 4. In an embodiment of the present invention, software components referenced in FIG. 4 represent a software program, a software object, a software function, a software subroutine, a software method, a software instance, and a code fragment, singly or in combination. In an alternate embodiment, functions performed by software components illustrated in FIG. 4 are carried out completely or partially by hardware.

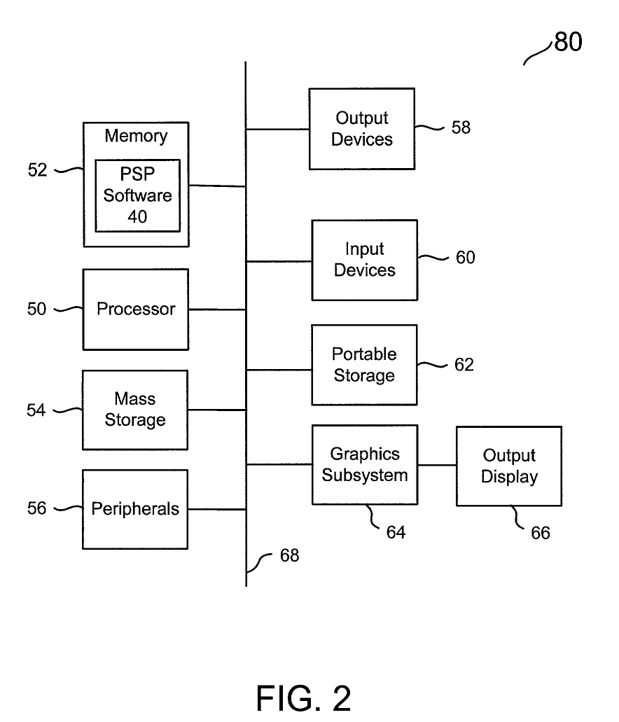

In an embodiment of the present invention, PSP software 40, or components of software 40, is stored in an article of manufacture, such as a computer readable medium. For example, software 40 is stored in a magnetic hard disk, an optical disk, a floppy disk, CD-ROM (Compact Disk Read-Only Memory), RAM (Random Access Memory), FLASH, ROM (Read-Only Memory), or other readable or writeable data storage technologies, singly or in combination. In an embodiment of the present invention, PSP software is stored in memory 52 illustrated in FIG. 2. In an alternate embodiment of the present invention, software components of PSP software 40 are distributed to multiple memory locations in PSP system 38.

II. Cross Promotions Engine

Instant and direct rewards are valuable volume-driving incentives for consumer brands. Cross Promotions Engine software component 41, illustrated in FIG. 4, allow entities to use the power of the Internet to create promotional programs based on monetary rewards. Using this capability, entities give money to their consumers in the form of alphanumeric sequences (as in- or on-packs, or any other distribution means) that are redeemable at partnering online retailers or at an interactive warehouse created for the program. This is a win-win enabling technology, as offline brands drive sales volume at their traditional channels and online retail partners receive increased qualified buying traffic to their sites, in addition to offline exposure.

Cross Promotion Engine software component works as follows: An entity, such as an offline retailer, delivers an alphanumeric sequence to consumers through an offline delivery mechanism (such as in-pack printing, stickers or cards). Each alphanumeric sequence has a specific value at targeted and synergistic online retailers partnered with offline retailer or at an electronic warehouse. Alphanumeric sequences are activated at a “promotion gateway,” a fully branded web site, integrated with the entities own web site, where consumers create an account, answer survey questions designed by the brand, and redeem their value at the online retail partners or electronic warehouses through proxying technology described in “Method And System For Proxying Web Pages”, by Bunger, et al., U.S. patent application Ser. No. 60/193,880, filed on Mar. 31, 2000, incorporated herein by reference.

A back-end system that supports Cross Promotions Engine software component 41 creates and handles the unique promotional alphanumeric sequences, which consumers can easily activate and redeem in order to take advantage of the promotion. During the promotional period, PSP system 38 collects valuable consumer information for the promotional partners, while at all times maintaining consumer privacy and a secure transactional process. This feature integrates with the platform to produce a seamless, fully branded redemption experience, launched from the entities own site or from a site created for the program.

III. Strategic Loyalty Engine

A loyalty program traditionally gives entities having brands the opportunity to create a long-term relationship with their consumers by giving them rewards based on purchased volumes over a period of time. The Internet is the ideal tool to manage a loyalty program. It allows consumers to easily accumulate and redeem value, and allows managers to easily administer and monitor a program based on business objectives and dynamic rules.

A Strategic Loyalty Engine software component 42, as illustrated in FIG. 4, is a flexible solution that an entity can use to create and power its own loyalty program. It is a technology that empowers entities to cover all aspects of an Internet-based loyalty initiative. PSP system 38 is flexible enough to allow brands to deliver many forms of value, such as instant money, sweepstakes, instant wins, collect-and-get and games. By having Strategic Loyalty Engine software component 42 interact with the other promotion functionalities, an entity is able to create a fully dynamic loyalty program that adapts to seasonality and changes in business objectives.

Strategic Loyalty Engine software component 42 is based on alphanumeric sequences, delivered to consumers via the purchase of a product. These alphanumeric sequences can represent value in many forms that range from monetary (currency based) to non-monetary (currency indifferent). Consumers go to an entities site to activate these alphanumeric sequences and add them to an account. Consumers can then convert their accumulated alphanumeric sequences into Internet money or other prize premiums as they reach pre-determined conversion levels based on the brand's business and volume-driving objectives. Additionally, this feature allows managers to use dynamic business rules to adapt the conversion rates to specific needs. For example, consumers can receive bonus value for buying specific SKUs, buying the product during a specific time window, performing viral marketing or answering a survey. The system can also read account activity on special occasions (like birthdays) and award bonuses based on that information. On the redemption side, the loyalty program can be combined with other promotion features, so that in addition to regular value-conversion, sweepstakes or gaming elements can be incorporated to enrich the consumer experience by expanding the choices for conversion and redemption.

In an alternate embodiment of the present invention, values associated with alphanumeric sequences are not accumulated.

Strategic Loyalty Engine software component 42 the loyalty engine functions on the principles of alphanumeric sequences accumulation and dynamic business rules for redemption in an embodiment of the present invention. Strategic Loyalty Engine software component 42 allows consumers to create accounts, add or accumulate value, add alphanumeric sequences and convert. PSP system 38 allows managers to create and change business rules, monitor account activity and modify conversion rates and redemption rules.

IV. Random Win Engine

Random Win Engine software component 43, as illustrated in FIG. 4, allows brands to run promotions based on program-specific winning odds and sweepstakes modes. In this kind of program, consumers find out the reward upon activating their alphanumeric sequences through the platform. This functionality allows a brand to create a program based on the following five different modes:

a) Instant-Win: Prizes

| | |
|---|---|
| Reward: | Special prizes served to consumers at random |
| | when they activate their alphanumeric |
| | sequences. All alphanumeric sequences have |
| | the same value, but only some consumers win |
| | grand prizes. |
| Example: | “Activate your $5 alphanumeric sequence and |
| | see if you are the winner of a trip to the Super |
| | Bowl!” |

b) Instant-Win: Value

| | |
|---|---|
| Reward: | Internet money served to consumers at |
| | random when they activate their alphanumeric |
| | sequences. Value of alphanumeric sequences |
| | ranges depending on the odds. |
| Example: | “Activate your alphanumeric sequence and see |
| | how much Internet money it's worth!” |

c) Instant-Win: Online Retailer(s)

| | |
|---|---|
| Reward: | Specific online retailer(s) at which to redeem |
| | the offer, served to consumers at random |
| | when they activate their alphanumeric |
| | sequences. All alphanumeric sequences have |
| | the same monetary value; the specific online |
| | retailer where this value is good is served upon |
| | activation. |
| Example: | “Activate your $10 alphanumeric sequence to |
| | see where you can instantly spend this |
| | money!” |

d) Enter-to-Win

| | |
|---|---|
| Reward: | A few grand prizes. Consumers can enter to |
| | win at the site as part of the alphanumeric |
| | sequence activation process. Prizes are then |
| | awarded at random by conducting a drawing at |
| | a later date, once all entries have been |
| | received. |
| Example: | “Enter your alphanumeric sequence for a |
| | chance to win $100,000!” |

e) Collect-and-Win

| | |
|---|---|
| Reward: | Users get their value once a “set” of game |
| | pieces (i.e. puzzle, matrix, etc.) is completed. |
| | Alphanumeric sequences act as the game |
| | pieces, and odds of completing sets are pre- |
| | determined and served to consumers at |
| | random every time they activate an |
| | alphanumeric sequence. In addition, some |
| | alphanumeric sequences can be pre-selected |
| | as winners of larger prizes to make the |
| | program more appealing. |
| Example: | “Activate your alphanumeric sequence to |
| | uncover a section of the baseball diamond!” |

The end result is a fully branded promotional program using the Internet as the rewarding vehicle, where an entity chooses what, how and when the rewards are given. Sweepstakes can power the program as a stand-alone feature, or can be combined with any other promotions to create/complement a larger program. In an embodiment of the present invention, PSP system 38 can manage all legal aspects to comply with federal and state sweepstakes regulations.

PSP system 38 supports sweepstakes functions with a combination of database flagging and algorithms to award prizes, rewards and values. Through a set-up process, parameters on sweepstakes modes, odds of winning, awarding mechanisms and online compliance with sweepstakes regulations for each program is set.

V. Tactical Repeat Purchase Engine

Many times, the goal of a promotion is to drive a specific minimum quantity of product during a short period of time, as opposed to longer-term loyalty. In the traditional promotions world, the best way to achieve this goal is by enticing consumers to collect or to play games where rewards are based on the quantity of product purchased. Tactical Repeat Engine software component 44, as illustrated in FIG. 4, utilizes the functionality of a PSP system 38 to run programs based on consumers completing a “set” that triggers the value once all the “pieces” have been collected. The Internet then functions as the place where consumers store individual game pieces to complete the set, just as a board game would function in the traditional world.

Tactical Repeat Engine software component 44 has a Collect-and-Get/Games capability that allows entities to design fully branded collect-and-get or game programs that fit their promotion goals and allow consumers to interact with their brands on the Internet. PSP system 38 also allows managers to specify the number of game pieces to activate different rewards.

Tactical Repeat Engine software component 44 is an Internet-enabled promotion based on the principles of short-term accumulation (collect-and-get) and interaction (games, puzzles, etc.) launched from an entities own site, or from a site specifically created for the program. This feature is based on alphanumeric sequences delivered to consumers via the purchase of a product. Consumers then go to the entity's site to activate these alphanumeric sequences; once activated, these alphanumeric sequences become “game pieces” that are presented to consumers as visual “pieces” of a game or puzzle that complete a set. Once a set (or sets) that activates a specific offer is completed, consumers redeem it online, either as real Internet money or as a specific offer/product at the online retailers participating in the program or at an electronic warehouse created for the program. Additionally, Tactical Repeat Engine software component 44 allows managers to use dynamic business rules to adapt the number of products purchased required to complete the sets. For example, consumers can receive bonus game pieces for buying specific Stock Keeping Units (“SKU”) or buying the product during a specific time window.

PSP system 38 that supports Tactical Repeat Engine software component 44 functions on the principles of piece/alphanumeric sequence accumulation and dynamic business rules for value redemption. Consumers create accounts, use their alphanumeric sequences to play games or fill in puzzles, and then redeem completed sets into Internet value (such as money). PSP system 38 allows managers to create and change business rules, monitor account activity and modify set completion odds and redemption rules.

Key features of Tactical Repeat Engine software component 44 include rewards that are based on the quantity of product purchased; allows offline entities to develop fully-branded programs that fit their promotion goals; and provides an incentive for consumers to interact with entities at their web site.

In addition to providing entities with PSP system 38 needed to create compelling Internet promotions, PSP system 38 empowers managers with valuable tools to use the information gathered through their programs to generate additional marketing opportunities. The data that is collected during a program can be used to target consumers with tailor-made offers in the future. Specifically, the following database tools are available:

VI. Monitoring and Reporting

Monitoring and Reporting software component 45, as illustrated in FIG. 4, allows for monitoring and in-depth & timely reporting on the promotion, including:

a) Access to consumer psychographics' and demographic information as well as consumption patterns and online behavior;

b) Data on promotion performance and key statistics;

c) Programmable reporting tools;

d) Ability to administer and change consumer surveys;

e) Integration with targeted email marketing and ad serving capabilities; and

f) Plug-ins with other promotion technologies from other vendors.

VII. Email Campaigns

Emails Campaigns software component 46, as illustrated in FIG. 4, allows for the collection of email addresses from consumers. Entities can use email capabilities to conduct campaigns targeting these consumers either during the program or at any time in the future using text or HTML messages. In order to comply with the law and protect consumer privacy, entities can only send email offers and messages to consumers who have provided their email addresses and opted to receive information during a program.

VIII. Ad Serving

Ad Serving software component 47, as illustrated in FIG. 4, allows for data collected through a promotion to be integrated with ad serving technologies to target consumers with individualized offers based on their stated preferences and behavior.

IX. Ongoing Services

Ongoing Services software component 48, as illustrated in FIG. 4, utilizes the data collected through a program to achieve any number of marketing goals, such as product sampling, consumer research, one-to-one marketing, or conducting other promotions based on the data captured.

X. Online Entities Participation

PSP system 38 empowers online entities with a powerful pay-for-performance mechanism to drive targeted traffic and sales to their web sites. Through the plug-and-play, web-based promotions infrastructure, online entities, such as online retailers, and offline branded consumer entities can use PSP system 38 to partner to create promotions that offer real value, such as electronic coupons, money and prizes, to their consumers.

An online entity can partner with an offline entity to execute a promotional program together with a promotion service provider. PSP system 38 allows the promotion to run seamlessly from the offline entities site to the online entities site, with no integration work required for the online entity. Consumers get a alphanumeric sequence and PIN in the offline world (through product packages, labels, stickers, cards or any other form), which they activate through PSP system 38. The alphanumeric sequence may be valid for a direct offer at an online retailer, an instant-win or sweepstakes opportunity, or consumers may be required to collect pieces or earn points before receiving a reward to use/spend at the online retailer. Consumers are sent directly to the online entities site, where they browse and select items to purchase as usual. PSP system 38 allows the offline entities web site (or the site created for the promotion) to seamlessly interface with the online retailer's site to apply the discount without the consumer re-entering the alphanumeric sequence.

Online and offline entities implement promotions by creating a truly low-risk, performance-based relationship. Offline entities usually pay for printing and distribution of the alphanumeric sequences to their consumers; advertising to support the promotional program; flags on packages to display online retailers' logos and announce the promotion; and program set-up and management fees, among other things. Online entities usually pay for the value of the offer, with their own merchandise/services.

Participating in a promotion provided by PSP system 38 requires relatively little, if any, integration time. An online entity provides a PSP system 38 with a valid electronic coupon or gift certificate alphanumeric sequences before the launch of a promotion. A processing device ties these alphanumeric sequences to the PSP's alphanumeric sequences and automatically inserts them in the appropriate field during the checkout process in an embodiment of the present invention. Because PSP system 38 uses alphanumeric sequences that are recognized by the online retailer's site, no (or minimal) changes to the online entities web sit is required. In addition, the consumer never views the online retailer's coupon or gift certificate alphanumeric sequences, so someone who has not obtained an alphanumeric sequence through the promotion cannot use them. The result is a seamless process to consumers and a hassle-free process to online entities.

Participating in promotions according to an embodiment of the present invention, provides online entities access to a true pay-for-performance customer acquisition tool, with the following benefits:

a) Driving highly qualified, targeted traffic: By partnering offline entities with online retailers that share similar consumer profiles, but do not compete for the same dollars;

b) Obtaining significant offline branding exposure: Promotional programs are usually backed by communication initiatives that can include packaging copy, TV advertising, free-standing inserts, print copy and many other marketing communication media that brands have always used to promote and communicate their promotions to consumers;

c) Building brand equity: By creating associations with strong offline entities that consumers have bought and trusted for years, online entities use the name, positioning and reputation of offline entities to strengthen their own brand equity and communicate their positioning; and

d) Results-oriented programs: More and more, the marketing model in the online world is moving towards investing resources in results-oriented programs. This trend has also been occurring in the offline world for the past ten years, as dollars are moved from advertising to tactical promotion budgets. A PSP system 38 empowers online entities to participate in these promotions to obtain truly qualified customers. To participate in these programs, online entities do not need to perform any engineering integration or spend time sourcing offline entities, plus they only pay when a customer is acquired.

XI. System

FIG. 1 depicts the components of an embodiment of the present invention. FIG. 1 shows a client processing device 2 which can be a personal computer or other device that is enabled to communicate on the Internet (e.g. telephone, web appliance, etc.). Client processing device 2 is equipped with a browser that can communicate on the Internet. A consumer would use client processing device 2 in order to transmit alphanumeric sequences, redeem rewards and make purchases online. In one embodiment, a user receives an award alphanumeric sequence in the packaging of a product. The consumer will log on to the offline retailer's web site by using client processing device 2 to access web site 4. Once the consumer has been given an award (e.g. online coupon), the consumer can access the online retailer's website 5 to redeem the award during a purchase.

Offline retailer's web site 4 is a collection of web servers, application servers, load balancers and firewalls that comprise and serve the retailer's web site in an embodiment of the present invention. In an alternate embodiment of the present invention, a single processing device is used to host web site 4. Because the make up and structure of the retailer's web site is not pertinent to the present invention, web site 4 is depicted symbolically with one icon.

In an embodiment of the present invention, after a user accesses the offline retailer's web site 4, the user will be provided with a link to the web servers 20, 22, 24 and 26. When a user clicks on that link, the user is redirected to web servers 20, 22, 24 and 26. FIG. 1 shows a load balancer 10 in communication with the Internet and four web servers: web server 20, web server 22, web server 24 and web server 26. When a user is redirected to the web servers 20, 22, 24 and 26, load balancer 10 determines which web server to redirect the communication (e.g. HyperText Transfer Protocol (“HTTP”) request) to based on the load of each of the web servers. The web servers then communicate with application servers 30 and 32. In one embodiment, a software load balancer 28 is used to balance the load that the web servers demand on the two application servers. The web servers are used to interface with clients, including receiving HTTP requests and providing HTTP responses. The web servers log transactions. If the request is a JHTM page or a “.dyn” file, then the web server passes the transaction directly to an application server. If the request is anything else, then web servers serve up the page. Application servers verify promotion alphanumeric sequences or new customer requests if a new customer creates an entry in a database and sets initial values. If the user supplies promotion alphanumeric sequences, application servers determine the promotion to verify that the alphanumeric sequence is acceptable. In an embodiment of the present invention, the application servers serve up pages for alphanumeric sequence specific promotions. In various alternatives, more or less than four web servers can be used and more or less than two application servers can be used.

Both application servers are in communication with shared database 34. Shared database 34 stores transaction logs, schemes, production tables, user tables, gift certificate tables, merchant tables, survey tables, system control tables, user tracking tables, sweepstakes tables and loyalty tables.

In an embodiment of the present invention, PSP software 40 is stored in application server 30 and 32, singly or in combination. In an alternate embodiment of the present invention, PSP software 40 is stored at offline retailer web site 4, and in particular a processing device for providing offline retailer web site 4.

FIG. 2 illustrates a high-level block diagram of a processing device 80 which can be used for the components of the present invention. The processing device 80 of FIG. 2 includes a processor unit 50 and main memory 52. Processor unit 50 may contain a single microprocessor, or may contain a plurality of microprocessors for configuring the processing device as a multi-processor system. Main memory 50 stores, in part, instructions and data for execution by processor unit 50. If the system of the present invention is wholly or partially implemented in software, main memory 52 can store the executable alphanumeric sequence when in operation. Main memory 52 may include banks of dynamic random access memory (DRAM) as well as high-speed cache memory. In an embodiment of the present invention, memory 52 stores PSP software 40.

A processing device of FIG. 2 further includes a mass storage device 54, peripheral device(s) 56, user input device(s) 60, portable storage medium drive(s) 62, a graphics subsystem 64 and an output display 66. In an alternate embodiment of the present invention, more or less components are provided. For purposes of simplicity, the components shown in FIG. 2 are depicted as being connected via a single bus 68. However, the components may be connected through one or more data transport means. For example, processor unit 50 and main memory 52 may be connected via a local microprocessor bus, and the mass storage device 54, peripheral device(s) 56, portable storage medium drive(s) 62, and graphics subsystem 64 may be connected via one or more input/output (I/O) buses. Mass storage device 54, which may be implemented with a magnetic disk drive or an optical disk drive, is a non-volatile storage device for storing data and instructions for use by processor unit 50. In an embodiment of the present invention, mass storage device 54 stores the PSP software 40 before loading to main memory 52.

Portable storage medium drive 62 operates in conjunction with a portable non-volatile storage medium, such as a floppy disk, to input and output data and alphanumeric sequence to and from a processing device of FIG. 2. In an embodiment of the present invention, PSP software 40 is stored on such a portable medium, and is input to processing device 80 via the portable storage medium drive 62. Peripheral device(s) 56 may include any type of computer support device, such as an input/output (I/O) interface, to add additional functionality to processing device 80. For example, peripheral device(s) 56 may include a network interface for connecting the processing device 80 to a network, a modem, a router, etc.

User input device(s) 60 provide a portion of a user interface. User input device(s) 60 may include an alpha-numeric keypad for inputting alpha-numeric and other information, or a pointing device, such as a mouse, a trackball, stylus, or cursor direction keys. In order to display textual and graphical information, a processing device of FIG. 2 includes graphics subsystem 64 and output display 66. Output display 66 may include a cathode ray tube (“CRT”) display, liquid crystal display (“LCD”) or other suitable display device. Graphics subsystem 64 receives textual and graphical information, and processes the information for output to display 66. Additionally, a processing device 80 of FIG. 2 includes output devices 58. Examples of suitable output devices include speakers, printers, network interfaces, monitors, etc.

The components contained in processing device 80 of FIG. 2 are those typically found in computer systems suitable for use with an embodiment of the present invention, and are intended to represent a broad category of such computer components that are well known in the art. Thus, processing device 80 of FIG. 2 can be a personal computer, workstation, server, minicomputer, mainframe computer, or any other computing device. Processing device 80 can also include different bus configurations, networked platforms, multi-processor platforms, etc. Various operating systems can be used including Unix, Linux, Windows, Macintosh OS, Palm OS, and other suitable operating systems.

In an embodiment of the present invention, processing device 80 is used as application server 30 illustrate in FIG. 1. In an alternate embodiment of the present invention, processing device 80 is used as a processing device for providing offline retailer web site 4.

XII. Method

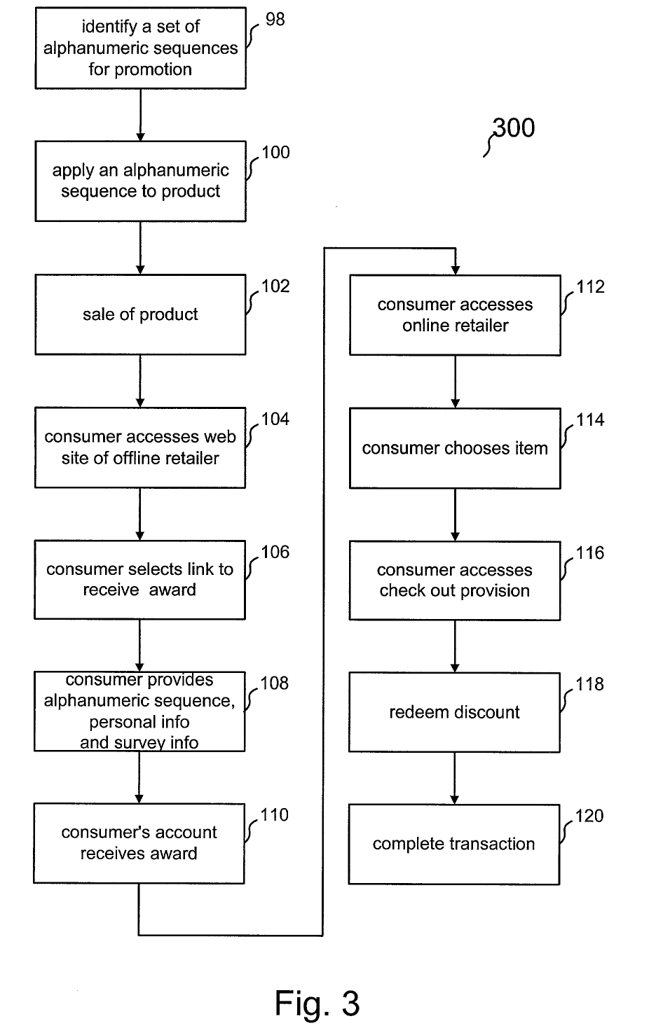

FIG. 3 illustrates a method 300 for providing promotions over the Internet according to an embodiment of the present invention. In an embodiment of the present invention, method 300 is performed by software components illustrated in FIG. 4. In an embodiment of the present invention, a logic box or step illustrated in FIG. 3 may represent an execution of a software component, such as a software program, a software object, a software function, a software subroutine, a software method, a software instance, a code fragment, singly or in combination. In an alternate embodiment of the present invention, a logic box or step represents execution of a software component, hardware operation, user operation, or retailer operation, singly or in combination. In an alternate embodiment of the present invention, fewer or more logic boxes or step are carried out in method 300.

Method 300 initiates in step 98 by identifying a set of alphanumeric sequences for use with a current promotion program. In step 100, an entity, such as a manufacture of a product, applies an alphanumeric sequence to the product. In an embodiment of the present invention, the alphanumeric sequence is applied so that a consumer cannot see the alphanumeric sequence until the consumer has purchased the product. For example, the alphanumeric sequence can be placed on the inside of packaging, or in an insert inside packaging for the product. In step 102, the product is sold. After the product is sold, the consumer has access to the alphanumeric sequence applied to the product. In addition to applying the alphanumeric sequence to the product, the manufacture will also include a Universal Resource Locator (“URL”) (or other identifier) for redeeming a prize or award associated with the alphanumeric sequence. The URL will be placed in proximity to the alphanumeric sequence. In one embodiment, the URL points to a web page of an offline retailer. In an embodiment of the present invention, an offline retailer is the manufacturer who applied the alphanumeric sequence in step 100. In another embodiment, an offline retailer is the entity that sells the product (as opposed to the manufacturer). In an alternative embodiment of the present invention, the URL is not pointing to a web page for the offline retailer, but is pointing to a web page provided by a promotion service provider. This web page of the promotion service provider can be customized for the particular product or manufacturer and (optionally) can be given the look and feel as if it was the web page for the manufacturer/offline retailer.

In step 104, the consumer accesses the web site for the offline retailer using the URL on the packaging. The web page for the offline retailer will have a link to another page for redeeming the award associated with the alphanumeric sequence. Typically, the web page will include the text “Click here to redeem award alphanumeric sequence.” In step 106, the consumer selects the link to receive the award and the consumer's browser is directed to a web page for providing information to redeem the award. In an embodiment of the present invention, the web page pointed to by the link for redirection is provided by the web servers (e.g. 20, 22, 24, 26 of PSP system 38). In another embodiment of the present invention, the web page pointed to by the link in step 106 is on the web server or processing device for an offline retailer. In step 108, the consumer provides the alphanumeric sequence, personal information and survey information into one or more web pages. In an embodiment of the present invention, the web page is used to accept the information that is provided by web servers 20, 22, 24, and 26 of the promotion's service provider. The personal information may include user name, log in information and demographic information. In an embodiment of the present invention, if a user has already entered the personal information, a user need only input a user name and password. If all the information is provided appropriately in step 108, the consumer's account receives value, such as an electronic coupon and/or award, in step 110. In an embodiment of the present invention, application servers 30 and/or 32 verify that the alphanumeric sequence entered in step 108 applies to an appropriate promotion and determines the value for that promotion. In an embodiment of the present invention, the user has an option to choose from a set of values. An example of a value is a $5.00 off electronic coupon at an online retailer. In an alternate embodiment of the present invention, values cannot be accumulated. In other embodiments of the present invention, values can be accumulated.

At any point after step 110, directly subsequent to or much later in time, the consumer can access the online retailer 5 in step 112 associated with the value. While accessing the online retailer (including accessing web pages for the online retailer), the user can choose an item to purchase in step 114. Typically, an online retailer will have a shopping cart. As a user chooses items, they are placed in a shopping cart. A user is provided a link to “check out.” When the user clicks “check out,” the user fills in all the information to purchase the item in step 116. After filling out all of the information, the user will click on a link for completing the transaction. After the user selects that link, the system automatically redeems the discount in step 118 and lowers the purchase price by the amount of the value. In step 120, the transaction is completed at the lower cost due to the discount from the value. One embodiment for performing steps 112-120 is discussed in the patent application incorporated by reference “Method and System for Proxying Web Pages” cited above. A web page for the online retailer is proxied by a promotion service provider so that when the user checks out, a user never has to know or enter a coupon number into a web page for the online retailer. PSP system 38 automatically enters the coupon number into the web page. The promotional service provider gets the coupon from the online retailer for purposes of the promotion.

In an embodiment of the present invention, PSP system 38 does not store alphanumeric sequences for each product sold. Rather, alphanumeric sequences are printed on packaging for the products and application servers 30 and 32 receive the alphanumeric sequences and enter the alphanumeric sequences into a decoding formula which determines whether they are valid or not.

Note that with the proxying of the online retailer's web site, the online retailer does not need to make any changes to its web site in order to participate in the promotion. In another alternative, the online retailer can create a fake product that is equal to −$5.00 or −$10.00, etc. depending on the amount of the value and step 118 would include adding that fake product to the shopping cart to reduce the amount of the purchase price by the value.

XIII. Conclusion

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claim is:

1) A method for providing a promotion, comprising the steps of:
(a) obtaining a product having an alphanumeric sequence;
(b) entering the alphanumeric sequence supplied with the product into a web page;
(c) validating the alphanumeric sequence;
(d) awarding a promotional value associated with the alphanumeric sequence;
(e) choosing an item for purchase;
(j) redeeming the item based on the promotional value; and,
(k) purchasing the item.

2) The method of claim 1, wherein the promotional value is an electronic coupon.

3) The method of claim 1, wherein the alphanumeric sequence is positioned inside packaging of the product.

4) The method of claim 1, wherein the alphanumeric sequence is positioned on the package of the product.

5) The method of claim 1, wherein an address of a web site is associated with the alphanumeric sequence and the method further comprise the step of accessing a web page associated the web site.

6) The method of claim 1, wherein the item is a service.

7) The method of claim 2, wherein the validating step includes decoding the alphanumeric code to determine an associated electronic coupon.

8) The method of claim 1, further comprising the step of collecting information from a buyer of the item.

9) The method of claim 2, further comprising the step of using the information for marketing purposes.

10) The method of claim 1, wherein the choosing step includes accessing an online retailer web site.

11) The method of claim 1, wherein the choosing step includes accessing an electronic warehouse.

12) A method for providing a promotion, comprising the steps of:
(a) applying an alphanumeric sequence to a product by a first retailer;
(b) selling the product by the first retailer to a user;
(c) accessing a web site on a first retailer processing device, by a user processing device;
(d) entering the alphanumeric sequence supplied with the product, by the user, into a web page of the web site;
(e) validating the alphanumeric sequence;
(f) awarding a promotional value;
(g) accessing a web site on a second retailer processing device, by the user processing device;
(h) choosing, by the user, an item for purchase;
(i) redeeming the item for purchase based on the promotional value; and,
(j) purchasing the item by the user.

13) The method of claim 12, wherein the promotional value is an electronic coupon.

14) The method of claim 12, wherein the item is a service.

15) The method of claim 13, wherein the electronic coupon can be accumulated in an account.

16) The method of claim 13, wherein the electronic coupon is increased responsive to the product purchased during a predetermined period of time.

17) The method of claim 13, wherein the electronic coupon is increased responsive to the product purchased in a predetermined geographic area.

18) The method of claim 13, wherein the electronic coupon is increased responsive to the user answering a question.

19) The method of claim 13, wherein the electronic coupon is increased responsive to a predetermined date.

20) The method of claim 13, wherein the awarding the coupon step includes awarding a prize.

21) The method of claim 13, wherein the awarding the coupon step includes activating internet money.

22) The method of claim 13, wherein the awarding the coupon step includes providing the second retailer that will redeem the coupon.

23) The method of claim 13, wherein the awarding the coupon step includes providing an opportunity to enter a sweepstake contest.

24) The method of claim 13, wherein the awarding the coupon step includes providing the user with a visual game piece associated with the alphanumeric sequence, and wherein a user wins a prize in response obtaining a plurality of predetermined visual game pieces.

25) An article of manufacture including a computer readable medium, comprising;
(a) a first software component for providing a value responsive to receiving an alphanumeric sequence from a first product;
(b) a second software component for directing a user to a web site for purchasing a second product; and,
(c) a third software component for purchasing the second product using the value.

26) The article of manufacture of claim 25, further comprising:
(d) a fourth software component for increasing the value responsive to a predetermined period of time.

27) The article of manufacture of claim 25, further comprising:
(d) a fourth software component for increasing the value responsive to the second product being purchased in a predetermined geographic area.

28) The article of manufacture of claim 25, further comprising:
(d) a fourth software component for increasing the value responsive to a user answering a question.

29) The article of manufacture of claim 25, further comprising:
(d) a fourth software component for increasing the value responsive to a predetermined date.

30) The article of manufacture of claim 25, further comprising:
(d) a fourth software component for awarding a prize.

31) The article of manufacture of claim 25, further comprising:
(d) a fourth software component for providing an opportunity to enter a sweepstake contest.

32) The article of manufacture of claim 25 further comprising:
(d) a fourth software component for providing the user with a game piece associated with the alphanumeric sequence, and wherein a user wins a prize in response obtaining a plurality of predetermined game pieces.

33) The article of manufacture of claim 25, wherein the computer readable medium is positioned in a processing device coupled to the Internet and a client processing device access the processing device.
